(19) United States
(12) Patent Application Publication
(10) Pub. No.: US 2018/0011312 A1
(43) Pub. Date: Jan. 11, 2018

(54) ATTENUATOR

(71) Applicant: Edinburgh Biosciences Limited, West Lothian (GB)

(72) Inventor: Desmond Smith, Livingston (GB)

(21) Appl. No.: 15/547,527

(22) PCT Filed: Feb. 1, 2016
(86) PCT No.: PCT/GB2016/050223

§ 371 Date: Jul. 31, 2017

(30) Foreign Application Priority Data
Jan. 30, 2015 (GB) 1501611.6

(51) Int. Cl. G02B 26/02; H01S 3/00; G02B 5/28

(52) U.S. Cl. CPC G02B 26/023; G02B 5/285; H01S 3/005

(57) ABSTRACT

The present invention relates to an attenuator for a light source that has a monochromatic output, and in particular a variable attenuator for such a source.

### FIELD OF THE INVENTION

The present invention relates to an attenuator for a light source that has a monochromatic output, and in particular a variable attenuator for such a source.

### BACKGROUND OF THE INVENTION

Attenuators are often used in optical systems to allow the power of laser beams to be varied and/or controlled. For high power lasers, known attenuators tend to be bulky, complex, and generally include multiple parts.

### SUMMARY OF THE INVENTION

According to the present invention, there is provided a laser attenuator for attenuating substantially single wavelength light, the laser attenuator comprising multi-layer optical coatings.

In another aspect of the invention, which may be provided independently, there is provided a laser attenuator for attenuating substantially single wavelength light, the laser attenuator comprising multiple layers of optical material arranged to provide a variable attenuation level.

The attenuator may comprise a single element.

The layers may comprise multiple layers of material that have different refractive indices, for example multiple thin layers of material that have different refractive indices. The attenuator may have multiple thin layers of material that have different refractive indices.

The layers may comprise variable thickness interference layers along the lateral direction. The attenuator may have variable thickness interference layers along the lateral direction.

The attenuator can be designed to attenuate the laser beam linearly with distance along the wedge or alternatively on a log scale.

The attenuator may comprise a transparent substrate such as glass, quartz or the like.

The number of layers can be different in different embodiments, for example between 10 and 100 layers, optionally 50 layers. The layers may comprise alternating higher and lower refractive index layers.

The layers may comprise reflective elements. The layers may provide reflectivity that varies along the lateral direction. The layers may comprise variable reflectivity layers in which the reflectivity varies with the lateral position. Each layer, or at least some of the layers, may comprise an optical coating, for example on a substrate, the optical coating(s) being selected to provide desired reflectivity and/or other optical properties.

The layers may be such as to provide a desired variation of transmissivity of the laser attenuator with lateral position, for example a substantially linear variation of transmissivity with lateral position or a substantially logarithmic variation of transmissivity with lateral position. The optical coatings may be selected to provide the desired variation of transmissivity with lateral position.

The attenuator may be movable in a direction that crosses the optical axis, for example perpendicular to the optical axis, thereby to vary the level of attenuation.

An attenuator actuator may be provided for moving the attenuator to vary the level of attenuation. The actuator may be automatically actuated. The actuator may, for example, comprise a worm and wheel and a stepper motor.

### BRIEF DESCRIPTION OF THE DRAWINGS

Various aspects of the invention will now be described by way of example only, and with reference to the accompanying drawings, of which:

FIG. 1 is schematic representation of a variable attenuator for a monochromatic light source, and

FIG. 2 shows a transmission curve as a function of position along the length of a wedge type interference attenuator.

### DETAILED DESCRIPTION OF THE DRAWINGS

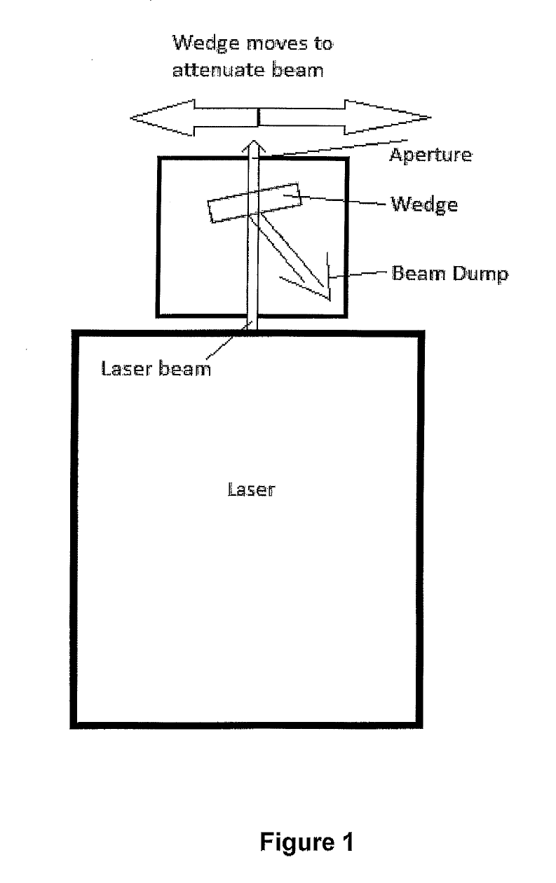

FIG. 1 shows a laser system that has laser for outputting a single wavelength output beam and a laser attenuator positioned along the optical path of the laser output beam. The laser attenuator is a wedge type interference device that has multiple layers of optical material.

The attenuator is located within a housing, in which a beam dump is provided for absorbing light reflected from the attenuator. An input is formed through one side of the housing to allow the laser beam to propagate along its optical path toward the interference attenuator. An output is formed through an opposite side of the housing to allow the attenuated laser beam to leave the housing.

The wedge interference device has multiple layers of variable thickness along the lateral direction. The interference layers can be designed to attenuate linearly with distance along the wedge or alternatively on a log scale.

The wedge type interference attenuator has a right-angled triangle cross section. The cross section has right angle defined by a long edge and a short edge, and an angled edge that extends between the long and short edges. The attenuator is positioned across the optical beam path so that its angled edge faces the optical beam, and its long edge is tilted slightly away from perpendicular to the beam path. Tilting of the wedge in this way allows light reflected from the attenuator to be diverted to the beam dump.

The attenuator is movable across the optical beam path. Movement can be achieved using a hand actuated mechanical drive or under electrical control. In either case, the attenuator can be calibrated as a function of position.

In use, the interference attenuator attenuates the laser beam as it passes through by reflecting some of the single wavelength light. Light reflected from the interference attenuator is diverted to the beam dump. The level of attenuation can be varied by moving the wedge shaped device across the optical beam path, so that the laser beam is incident at different positions along the angled face.

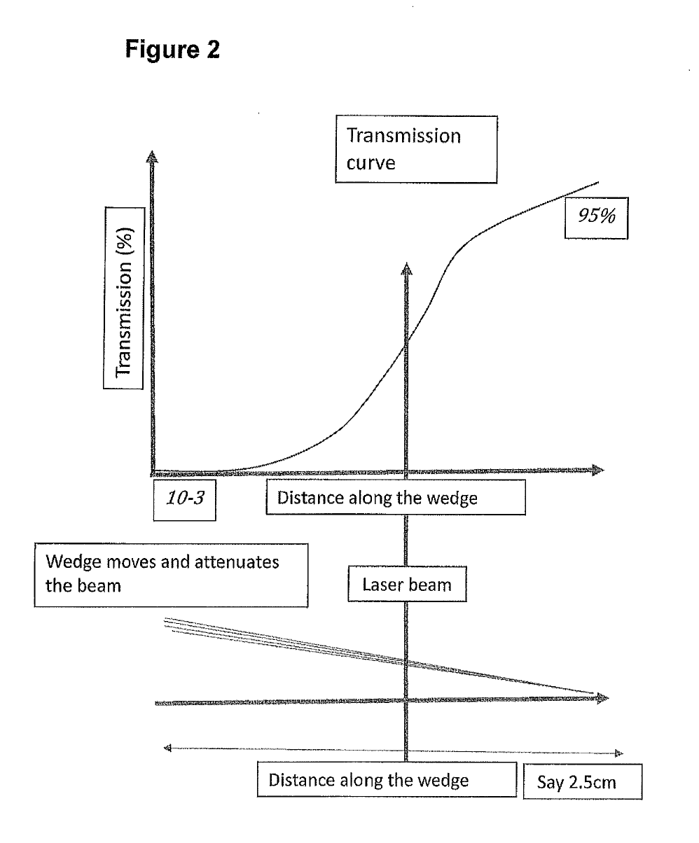

FIG. 2 shows a transmission curve as a function of position along the length of the wedge type attenuator at an example wavelength of 800 nm. This shows that the transmission varies from roughly 95% at one end of the wedge to around 0% at the other. This demonstrates that the attenuator can be used to provide a variable level of attenuation. The attenuation level can be selected merely by varying the position of the attenuator relative to the laser beam.

A skilled person will appreciate that variations of the disclosed arrangements are possible without departing from the invention.

In some embodiments the layers may comprise variable reflectivity layers in which the reflectivity varies with position along the lateral direction.

The layers in some embodiments each comprise an optical coating, the optical coating being deposited or otherwise formed on a substrate and being selected to provide desired reflectivity and/or other optical properties.

The layers may be such as to provide a desired variation of transmissivity of the laser attenuator with lateral position, for example a substantially linear variation of transmissivity with lateral position or a substantially logarithmic variation of transmissivity with lateral position.

For example, in some embodiments the layers are such as to provide a linear variation of transmissivity between 100% and 1%, or between any other desired values. In other embodiments, in which a substantially logarithmic variation of transmissivity with lateral position is provided the transmissivity may, for example, vary by a factor of 0.0001 or more (e.g. from around 100% to around 0.01%). Such variation of transmissivity may, for example, be particularly suitable when the attenuator is used to attenuate a high power laser beam, for example a laser beam having peak power in the MW range, for instance 1 MW to 100 MW, for optical alignment or other purposes.

The number of layers can be different in different embodiments, for example between 10 and 100 layers, optionally 50 layers.

The above description of a specific embodiment is made by way of example only and not for the purposes of limitations. It will be clear to the skilled person that minor modifications may be made without significant changes to the operation described.

1. A laser attenuator for attenuating substantially single wavelength light, the laser attenuator comprising multiple layers of optical material arranged to provide a variable attenuation level.

2. A laser attenuator as claimed in claim 1 comprising variable thickness interference layers along the lateral direction.

3. A laser attenuator as claimed in claim 1, comprising a transparent substrate such as glass, quartz or the like.

4. A laser attenuator as claimed in claim 1 that is wedge shaped.

5. A laser attenuator as claimed in claim 1 comprising an actuator for moving the attenuator across a path of the laser beam.

6. A laser attenuator as claimed in claim 5 wherein the actuator for moving the filter comprises a worm wheel and a stepper motor.
